(19) United States
(12) Patent Application Publication
(10) Pub. No.: US 2016/0027558 A1
(43) Pub. Date: Jan. 28, 2016

(54) Tape Wrapped Unshielded Twisted Pair Cable For High Speed Data Transmissions

(71) Applicant: DELPHI TECHNOLOGIES, INC., Troy, MI (US)

(72) Inventors: Richard J. Boyer, Mantua, OH (US); John F. Heffron, Youngstown, OH (US)

(21) Appl. No.: 14/775,870

(22) PCT Filed: Jan. 13, 2015
(86) PCT No.: PCT/US15/11097

§ 371 Date: Sep. 14, 2015

Related U.S. Application Data
(60) Provisional application No. 61/932,399, filed on Jan. 28, 2014.

(51) Int. Cl. H01B 13/012; H01B 7/17; H01B 11/02

(52) U.S. Cl. CPC H01B 13/01263; H01B 11/02; H01B 7/17

(57) ABSTRACT

A method to construct a tape wrapped unshielded twisted pair (UTP) cable is provided. The method includes the step of twisting a first wire and a second wire together to form a twisted pair. The method further includes the step of wrapping tape around the twisted pair with an effective amount of tension on the tape such that a separation distance between the first wire and second wire does not substantially vary along the length of the twisted pair.

### CROSS-REFERENCE TO RELATED APPLICATION

This application is a national stage application under 35 U.S.C. §371 of PCT Application No. PCT/US2015/11097 having an international filing date of Jan. 13, 2015 which designated the United States, and which claims the benefit of priority under Article 8 of the Patent Cooperation Treaty to U.S. Provisional Patent Application No. 61/932,399, filed Jan. 28, 2014, the entire disclosure of each of which are hereby incorporated herein by reference.

### TECHNICAL FIELD OF INVENTION

This disclosure generally relates to a method to construct an unshielded twisted pair (UTP) cable and more particularly relates to a method to construct an unshielded twisted pair cable for high speed data transmissions using wrapped tape.

### BACKGROUND OF INVENTION

As vehicle electronic module to module communication technology continues to evolve and grow, there is a growing need for a cost effective and reliable signal transmission cable that is capable of transmitting signals at data rates that exceed 50 megabits per second (Mbps). Prior examples of a cost effective and robust UTP cable construction used in dual cable data communication applications that included two signal wires twisted together and wrapped with a protective tape were not capable of transmitting data at rates that exceed 50 Mbps. This is due to signal reflections that are generated within the wires when the data rates exceed 50 Mbps. These signal reflections are generated as a result of excessive variation in the spacing between the twisted wires which causes the impedance level of the wires to fluctuate excessively along the length of the UTP cable.

Methods and techniques for controlling the spacing between the wires of a UTP cable are known, such as welding or adhesively bonding the insulation of the wires together, but these methods and techniques add to the overall cost of producing the UTP cable.

### SUMMARY OF THE INVENTION

In accordance with one embodiment, a method to construct a tape wrapped UTP cable is provided. The method includes the step of twisting a first wire and a second wire together to form a twisted pair. The method further includes the step of wrapping tape around the twisted pair with an effective amount of tension on the tape such that a separation distance between the first wire and second wire does not substantially vary along the length of the twisted pair.

In accordance with another embodiment, a tape wrapped unshielded twisted pair cable for high speed data transmissions is provided. The cable includes a first wire. The cable further includes a second wire twisted together with the first wire to form a twisted pair. The cable further includes a tape wrapped around the twisted pair to control a separation distance between the first wire and the second wire such that the separation distance does not substantially vary.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a perspective view of a tape wrapped UTP cable in accordance with one embodiment;

FIG. 2 is a sectional view of the tape wrapped UTP cable;

FIG. 3 is flowchart illustrating a method for making the tape wrapped UTP cable in accordance with one embodiment; and

FIG. 4 is an illustration demonstrating how a protective tape of the tape wrapped UTP cable is wrapped around a twisted pair of the tape wrapped UTP cable in accordance with one embodiment.

### DETAILED DESCRIPTION

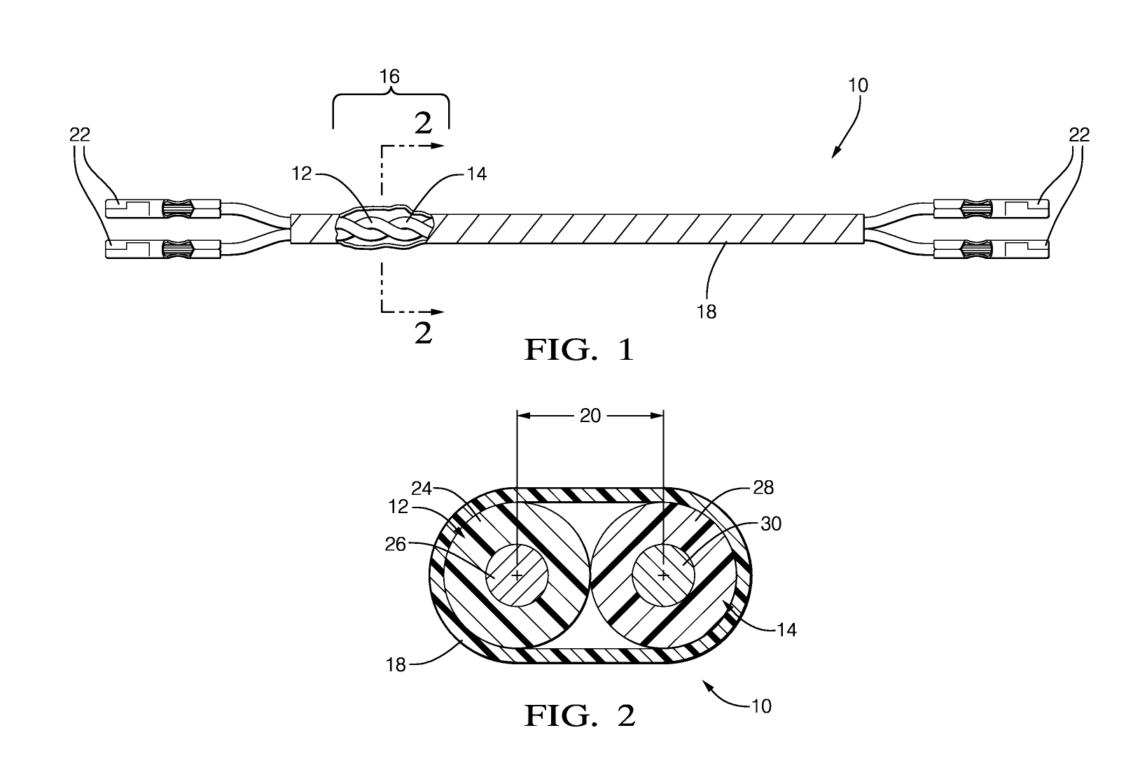

FIG. 1 illustrates a non-limiting example of a tape wrapped UTP cable 10 that is capable of transmitting data at rates that exceed 50 Mbps. The cable 10 includes a first wire 12 and a second wire 14 that are twisted together to form a twisted pair 16. A protective tape 18 is wrapped around the twisted pair 16 to protect the first wire 12 and the second wire 14, and to control a separation distance 20 (FIG. 2) between the first wire 12 and second wire 14 such that the separation distance 20 does not substantially vary. As used herein, the term substantially vary means a variance in the separation distance 20 that causes the characteristic impedance (Z₀) along the length of the cable 10 to fluctuate by more than 10% of the nominal value. This control of the separation distance 20 differentiates the cable 10 described herein from known UTP cable constructions that utilize similar materials. The cable 10 also includes terminals 22 that are attached to the ends of the first wire 12 and the second wire 14 for making an electrical connection between electrical devices (not shown).

FIG. 2 illustrates a section of the cable 10 cut through the twisted pair 16. The first wire 12 includes a first insulation 24 and a first core 26, and the second wire 14 includes a second insulation 28 and a second core 30. The first insulation 24 is not welded or adhesively bonded to the second insulation 28. In the example shown, the separation distance 20 is characterized as the distance between the centers of the first core 26 and the second core 30. The inventors have observed that applying the protective tape 18 to the twisted pair 16 with sufficient overlap 32 and tension 34 is effective to control the separation distance 20 adequately so that welding or adhesively bonding the first and second insulation 24, 28 together is unnecessary.

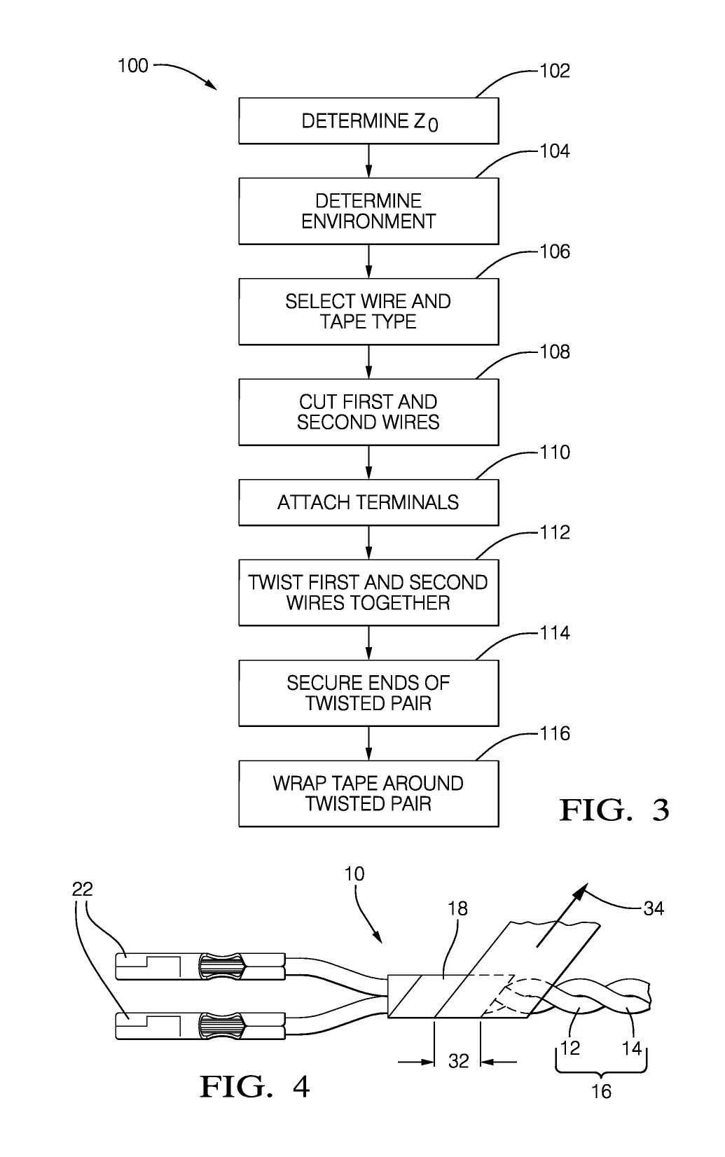

FIG. 3 illustrates a non-limiting example of a method 100 to construct the cable 10. The method 100 is described below starting with step 102.

Step 102, DETERMINE Z₀, includes determining the required Z₀ for the cable 10 based on the specified data communications protocol. For example, the Ethernet physical layer specification specifies a Z₀ of 100 ohms

Step 104, DETERMINE ENVIRONMENT, includes determining the intended environment for the cable 10. For example, whether the cable 10 will be utilized in a vehicle interior or vehicle exterior environment. By way of example and not limitation, vehicle exterior underhood applications may be exposed to higher temperatures of 125° C., compared to maximum vehicle interior temperatures of 85° C.

Step 106, SELECT WIRE AND TAPE TYPE, includes selecting a wire type for the first wire 12 and the second wire 14, and a tape type for the protective tape 18 based on the required Z₀ determined in step 102 and the intended environment determined in step 104. For example, for constructing the cable 10 with a Z₀ of approximately 100 ohms for usage in a vehicle interior environment, an appropriate wire type may be insulated signal wire with a 0.75 millimeter (mm) core diameter and 0.41 mm thick poly vinyl chloride (PVC) insulation and an appropriate tape type may be 20 mm wide non-adhesive backed PVC tape. The selection of the wire type and tape type may be done empirically and/or analytically.

Step 108, CUT FIRST AND SECOND WIRES, includes cutting the first wire 12 and the second wire 14 to the desired length for the cable 10.

Step 110, ATTACH TERMINALS, includes attaching the terminals 22 to the ends of the first wire 12 and the second wire 14. Attaching the terminals may be by the way of crimping or soldering, as will be recognized by those in the art.

Step 112, TWIST FIRST AND SECOND WIRE TOGETHER, includes twisting the first wire 12 and the second wire 14 together to form the twisted pair 16. The appropriate number of twists for the twisted pair 16 may be determined based on the desired electromagnetic compatibility (EMC) characteristic for the cable 10. For example, for usage in a vehicle interior environment, the number of twists may be 45 twists per meter in order to meet the electromagnetic radiated fields requirement specified in ISO (International Organization for Standardization) 11452-2. The appropriate number of twists may be determined empirically.

Step 114, SECURE ENDS OF TWISTED PAIR, includes securing the ends of the twisted pair 16 such that the twisted pair 16 does not unravel prior to the protective tape 18 being applied in Step 116. The ends of the twisted pair 16 may be secured by wrapping adhesive backed PVC tape (not shown) around the ends of the twisted pair 16 near the terminals 22.

Step 116, WRAP TAPE AROUND TWISTED PAIR, includes wrapping the protective tape 18 around the twisted pair 16 with an effective amount of overlap 32 (FIG. 4) and tension 34 (FIG. 4) on the protective tape 18 such that the separation distance 20 between the first wire 12 and second wire 14 does not substantially vary along the length of the twisted pair 16. For example, wrapping 20 mm wide non-adhesive backed PVC tape with approximately 50 percent overlap 32 and twenty (20) newtons (N) of tension 34 around the twisted pair 16 described in the preceding examples has been observed to be effective for keeping the separation distance 20 from substantially varying. As used herein, the term approximately 50 percent means within 45 to 55 percent overlap. The overlap 32 and tension 34 required to keep the separation distance 20 from substantially varying may be empirically determined. The protective tape 18 may be applied with known tape dispensing machines, such as a Cam Innovation or Ondal spiral taping machines. An adhesive tape (not shown) may be applied to the ends of the protective tape 18 to prevent it from unraveling.

Accordingly, a tape wrapped UTP cable 10 for transmitting data at transmission rates that exceed 50 Mbps and a method 100 for producing the tape wrapped UTP cable 10 are provided. The method 100 provides a low cost means for producing a UTP cable that is capable of transmitting data at rates that exceed 50 Mbps by elimination of the need to weld or bond the insulation of the twisted pair to control separation distance.

While this invention has been described in terms of the preferred embodiments thereof, it is not intended to be so limited, but rather only to the extent set forth in the claims that follow.

1. A method to construct a tape wrapped unshielded twisted pair cable, said method comprising:
twisting a first wire and a second wire together to form a twisted pair; and
wrapping non-adhesive backed PVC tape around the twisted pair with an effective amount of tension on the tape such that a separation distance between the first wire and second wire does not substantially vary along the length of the twisted pair.

2. The method according to claim 1, wherein the effective amount of tension is approximately 20 newtons.

3. The method according to claim 1, wherein the step of wrapping tape further includes wrapping the tape with an effective amount of overlap on the tape such that the separation distance between the first wire and second wire does not substantially vary along the length of the twisted pair.

4. The method according to claim 3, wherein the effective amount of overlap is approximately 50 percent.

5. A tape wrapped unshielded twisted pair cable for high speed data transmissions, said cable comprising:
a first insulated wire;
a second insulated wire twisted together with the first wire to form a twisted pair; and
a non-adhesive backed PVC tape wrapped around the twisted pair to control a separation distance between the first wire and the second wire such that the separation distance does not substantially vary.

6. The cable according to claim 5, wherein a first insulation of the first wire and a second insulation of the second wire are not adhesively bonded or welded together.

7. A tape wrapped unshielded twisted pair cable for high speed data transmissions, said cable consisting of:
a first insulated wire;
a second insulated wire twisted together with the first wire to form a twisted pair; and
a non-adhesive backed PVC tape wrapped around the twisted pair to control a separation distance between the first wire and the second wire such that the separation distance does not substantially vary.

8. The cable according to claim 7, wherein a first insulation of the first wire and a second insulation of the second wire are not adhesively bonded or welded together.
